(19) United States
(12) Patent Application Publication
(10) Pub. No.: US 2025/0125363 A1
(43) Pub. Date: Apr. 17, 2025

(54) BINDER FOR NEGATIVE ELECTRODE OF RECHARGEABLE LITHIUM BATTERY, NEGATIVE ELECTRODE FOR RECHARGEABLE LITHIUM BATTERY INCLUDING THE SAME AND RECHARGEABLE LITHIUM BATTERY INCLUDING THE SAME

(71) Applicant: SAMSUNG SDI CO., LTD., Yongin-si (KR)

(72) Inventors: Yun Shik CHO, Suwon-si (KR); Kuk Joo LEE, Suwon-si (KR); Kyung Hwa JUNG, Suwon-si (KR); Je Won CHOI, Suwon-si (KR); Su Jin PARK, Suwon-si (KR); Min Ho CHO, Suwon-si (KR); Fukatani TOMOYUKI, Suwon-si (KR)

(21) Appl. No.: 18/904,620

(22) Filed: Oct. 2, 2024

(30) Foreign Application Priority Data
Oct. 11, 2023 (KR) 10-2023-0134923

(51) Int. Cl. H01M 4/62; H01M 4/02; H01M 10/0525

(52) U.S. Cl. CPC H01M 4/622; H01M 10/0525; H01M 2004/027; H01M 2220/30

(57) ABSTRACT

A binder for a negative electrode of a rechargeable lithium battery, a negative electrode for a rechargeable lithium battery including the same, and a rechargeable lithium battery including the same are provided. The binder includes a copolymer constructed from a unit derived from an aromatic vinyl-based monomer, a unit derived from a (meth)acrylic ester-based monomer, and a unit derived from a triene-based monomer.

### CROSS-REFERENCE TO RELATED APPLICATION

This application claims priority to and the benefit of Korean Patent Application No. 10-2023-0134923, filed on Oct. 11, 2023, in the Korean Intellectual Property Office, the entire content of which is incorporated herein by reference.

### BACKGROUND

### 1. Field

According to one or more embodiments, the present disclosure relates to a binder for a negative electrode of a rechargeable lithium battery, a negative electrode for a rechargeable lithium battery including the same, and a rechargeable lithium battery including the same.

### 2. Description of the Related Art

In response to the recent rapid spread of electronic devices that use rechargeable lithium batteries, such as mobile phones, laptop computers, electric vehicles, and/or the like, the demand for secondary batteries with relatively high energy density and high capacity is rapidly increasing. Accordingly, research and development to improve the performance of lithium secondary batteries is actively ongoing.

The rechargeable lithium battery is a battery including a positive electrode and a negative electrode, which include active materials capable of intercalating and deintercalating lithium ions. The battery includes an electrolyte and generates electrical energy by oxidation and reduction reactions if (e.g., when) lithium ions are intercalated/deintercalated into/from a positive electrode and a negative electrode.

It is required (or there is a desire) that the negative electrode for the rechargeable lithium battery has low electrode plate resistance and high adhesion of the negative electrode active material layer to a current collector.

### SUMMARY

One or more aspects are directed toward a binder for a negative electrode of a rechargeable lithium battery, which implements a negative electrode active material layer having low negative plate resistance and high adhesion to a current collector.

One or more aspects are directed toward a negative electrode for a rechargeable lithium battery, which includes the herein-described binder, and a rechargeable lithium battery including the negative electrode.

One or more aspects are directed toward a binder for a negative electrode of a rechargeable lithium battery, which includes a unit derived from an aromatic vinyl-based monomer, a unit derived from a (meth)acrylic ester-based monomer, and a unit derived from a triene-based monomer.

One or more aspects are directed toward a negative electrode for a rechargeable lithium battery, which includes the herein-described binder.

One or more aspects are directed toward a rechargeable lithium battery, which includes the herein-described negative electrode for a rechargeable lithium battery, a positive electrode, and an electrolyte.

One or more aspects are directed toward a binder for a negative electrode of a rechargeable lithium battery capable of providing a negative electrode active material layer having low negative plate resistance and high adhesion to a current collector.

Additional aspects will be set forth in part in the description which follows and, in part, will be apparent from the description, or may be learned by practice of the presented embodiments of the disclosure.

### BRIEF DESCRIPTION OF THE DRAWINGS

The preceding and other objects, features and advantages of the present disclosure will become more apparent to those of ordinary skill in the art by describing example embodiments thereof in more detail with reference to the accompanying drawings. In the drawings:

FIGS. 1-4 are each a schematic diagram of a rechargeable lithium battery according to one or more embodiments; and

FIG. 5 shows a method of adhesion measurement regarding Experimental Example 2.

### DETAILED DESCRIPTION

In order to sufficiently understand the configuration and effect of the present disclosure, example embodiments of the present disclosure will be described in more detail with reference to the accompanying drawings, and may be easily practiced by a person skilled in the art. However, it should be noted that this is provided by way of example, and the present disclosure is not limited thereby and is only defined by the scope of the claims described in more detail herein. Rather, the example embodiments are provided only to disclose the present disclosure and let those skilled in the art fully know the scope of the present disclosure.

In the drawings, the thickness of layers, films, panels, regions, and/or the like, are exaggerated for clarity and like reference numerals designate like elements throughout, and duplicative descriptions thereof may not be provided the specification. Unless stated otherwise in the specification, if (e.g., when) a portion of a layer, film, region, plate and/or the like is referred to as being “on” another portion, this includes not only the case in which the portion is “directly on” another portion but also the case in which there is another portion interposed therebetween.

Unless stated otherwise in the specification, singular expressions may include plural expressions. Also, unless stated otherwise, “A or B” may refer to “including A, including B, or including A and B.”

In the specification, a “combination thereof” may refer to a mixture, laminate, composite, copolymer, alloy, blend, and reaction product of constituents.

The terms “comprises,” comprising,” “comprise,” “including,” “includes,” “include,” “having,” “has,” and “have,” as used in this description, are intended to designate the presence of an embodied aspect, number, step (e.g., act or task), element, and/or a (e.g., any suitable) combination thereof. However, the use of these terms does not preclude or exclude the possibility of the presence or addition of one or more other components, features, numbers, steps (e.g., acts or tasks), elements, and/or a (e.g., any suitable) combination thereof.

In one or more embodiments, the term “layer” herein includes not only a shape formed or provided on the whole surface if (e.g., when) viewed from a plan view, but also a shape formed or provided on a partial surface.

It will be understood that, although the terms “first,” “second,” “third,” and/or the like may be utilized herein to describe one or more suitable elements, components, regions, layers and/or sections, these elements, components, regions, layers and/or sections should not be limited by these terms. These terms are only utilized to distinguish one element, component, region, layer or section from another element, component, region, layer, or section. Thus, a first element, component, region, layer, or section described herein may be termed a second element, component, region, layer or section without departing from the teachings set forth herein.

As utilized herein, the term “and/or” includes any, and all, combinations of one or more of the associated listed items. Expressions such as “at least one of,” “one of,” and “selected from,” if (e.g., when) preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Spatially relative terms, such as “beneath,” “below,” “lower,” “above,” “upper,” and/or the like, may be utilized herein to easily describe the relationship between one element or feature and another element or feature. It will be understood that the spatially relative terms are intended to encompass different orientations of a device in utilization or operation in addition to the orientation illustrated in the drawings. For example, if (e.g., when) the device in the drawings is turned over, elements described as “below” or “beneath” other elements or features will be oriented “above” the other elements or features. Thus, the example term “below” can encompass both (e.g., simultaneously) the orientations of above and below. The device may be otherwise oriented (rotated 90 degrees or at other orientations), and the spatially relative terms utilized herein may be interpreted accordingly.

Unless otherwise defined, all terms (including chemical, technical and scientific terms) utilized herein have the same meaning as commonly understood by one of ordinary skill in the art to which this disclosure pertains. It will be further understood that terms, such as those defined in commonly utilized dictionaries, should be interpreted as having a meaning that is consistent with their meaning in the context of the related art and the present disclosure, and will not be interpreted in an idealized or overly formal sense.

Example embodiments are described herein with reference to cross-sectional views, which are schematic views of idealized embodiments. As such, variations from the shapes of the illustrations as a result, for example, of manufacturing techniques and/or tolerances, are to be expected. Thus, embodiments described herein should not be construed as being limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the drawings are schematic in nature and their shapes are not intended to illustrate the precise shape of a region and are not intended to limit the scope of the present claims.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item. Descriptions of features or aspects within each embodiment should typically be considered as available for other similar features or aspects in other embodiments.

In this context, “consisting essentially of” indicates that any additional components will not materially affect the chemical, physical, optical or electrical properties of the semiconductor film.

Further, in this specification, the phrase “on a plane,” or “plan view,” indicates viewing a target portion from the top, and the phrase “on a cross-section” indicates viewing a cross-section formed by vertically cutting a target portion from the side.

In the context of the present application and unless otherwise defined, the terms “use,” “using,” and “used” may be considered synonymous with the terms “utilize,” “utilizing,” and “utilized,” respectively.

Unless otherwise defined in the specification, a particle diameter may be an average particle diameter. Also, a particle diameter refers to an average particle diameter (D50) corresponding to a cumulative volume of 50 vol % in the particle size distribution. An average particle diameter (D50) may be measured by a method widely suitable in the art, for example, using a particle size analyzer, a transmission electron microscope image, or a scanning electron microscope image. As another method, an average particle diameter (D50) may be obtained by performing measurement with a measuring instrument using a dynamic light scattering method, analyzing data to count the number of particles for each particle size range, and calculating an average particle diameter from the result. In one or more embodiments, measurement may be made using a laser diffraction method. For example, if (e.g., when) measurement is made using a laser diffraction method, particles to be measured are dispersed in a dispersion medium and then irradiated with ultrasound having a frequency of about 28 kHz at an output of 60 W using a commercially available laser diffraction particle diameter measuring instrument (e.g., MT 3000 commercially available from Microtrac), and an average particle diameter (D50) corresponding to 50% in the particle diameter distribution in the measuring instrument is calculated.

In the specification, “(meth)acrylic” refers to acrylic and/or methacrylic.

In the specification, if (e.g., when) a numerical range is described, the expression “X to Y” refers to “X or more and Y or less (X≤and ≤Y).”

### Binder for Negative Electrode of Rechargeable Lithium Battery

A binder for a negative electrode of a rechargeable lithium battery according to one or more embodiments includes a unit derived from an aromatic vinyl-based monomer, a unit derived from a (meth)acrylic ester-based monomer, and a unit derived from a triene-based monomer.

A binder including a unit derived from an aromatic vinyl-based monomer and a unit derived from a (meth)acrylic ester-based monomer may decrease negative plate resistance if (e.g., when) applied in a negative electrode active material layer. However, a negative electrode active material layer including the binder may have low adhesion to a current collector. In some embodiments, a negative electrode including a negative electrode active material layer having high adhesion to a current collector is advantageous. For example, the negative electrode including a negative electrode active material layer having high adhesion may increase the reliability of a rechargeable lithium battery.

The unit derived from a triene-based monomer may implement a negative electrode active material layer having high adhesion to a current collector while maintaining low negative plate resistance, which is implemented by the binder.

The triene-based monomer may be a compound (e.g., organic small molecule) having three double bonds in one monomer. If (e.g., when) this monomer is copolymerized with an aromatic vinyl-based monomer and a (meth)acrylic ester-based monomer, one or two double bonds that remain unpolymerized may be present in a free state (e.g., unreacted form). The double bond present in a free state (e.g., unreacted form) may be available (e.g., is expected) to increase the adhesion of a negative electrode active material layer to a current collector by allowing additional (e.g., molecular scale) interactions with a current collector. For example, copper atoms of a copper current collector. However, without being bound by any particular theory, it is believed that an increase in adhesion, which is implemented by the binder according to one or more embodiments described herein, is not limited thereto.

In one or more embodiments, the binder may be a (meth)acrylic copolymer of a monomer mixture, e.g., the monomer mixture including an aromatic vinyl-based monomer, a (meth)acrylic ester-based monomer, and a triene-based monomer.

In one or more embodiments, the triene-based monomer may (e.g., needs to) be included in an appropriate or suitable content (e.g., amount) range with respect to the total amount of the aromatic vinyl-based monomer and the (meth)acrylic ester-based monomer. Thereby, adhesion to a current collector may be increased while the aspect of the unit derived from an aromatic vinyl-based monomer and the unit derived from a (meth)acrylic ester-based monomer on decreasing negative plate resistance may not be affected. For example, the triene-based monomer may be included in an amount of about 1 to about 100 parts by weight, for example, about 1, 5, 10, 15, 20, 25, 30, 35, 40, 45, 50, 55, 60, 65, 70, 75, 80, 85, or 90 parts by weight, for example, about 1 to about 90 parts by weight, about 5 to about 60 parts by weight, about 10 to about 60 parts by weight, or about 1 to about 50 parts by weight, with respect to the total amount (100 parts by weight) of the aromatic vinyl-based monomer and the (meth)acrylic ester-based monomer. Within the described ranges, an adhesion improvement aspect resulting from addition of the triene-based monomer to a combination of the aromatic vinyl-based monomer and the (meth)acrylic ester-based monomer may be achieved or implemented.

In one or more embodiments, the triene-based monomer may be included in an amount of about 3 wt % to about 45 wt % in the monomer mixture with respect to a total amount of the monomer mixture. Within the described range, if (e.g., when) the triene-based monomer is copolymerized with the aromatic vinyl-based monomer and the (meth)acrylic ester-based monomer, a significant aspect of decreasing negative plate resistance and increasing adhesion may be achieved or implemented, and the function of a negative electrode may not be affected (or substantially affected). For example, the triene-based monomer may be included in an amount of about 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, or 45 wt %, for example, about 5 wt % to about 45 wt %, about 15 wt % to about 40 wt %, about 10 wt % to about 30 wt %, about 5 wt % to about 35 wt %, or about 5 wt % to about 25 wt % with respect to a total amount of the monomer mixture. Within the described ranges, negative plate resistance may significantly decrease, and adhesion may also significantly increase.

In one or more embodiments, the monomer mixture may exclude (e.g., be substantially free of) a diene-based monomer. The binder may exclude a (e.g., be substantially free of any) unit derived from a diene-based monomer. Here, the “diene-based monomer” may be a monomer having two double bonds in one monomer, and a typical type or kind of diene-based monomer suitable in the art may be used. For example, the diene-based monomer may be a C4 to C10 diene-based monomer, and for example, may be butadiene. Here, “substantially free of” refers to that the diene-based monomer may be included in an amount of about 0.1 wt % or less, for example, 0 to about 0.1 wt % or 0 wt %, in the monomer mixture, and that the unit derived from a diene-based monomer may be included in an amount of about 0.1 wt % or less, for example, 0 to about 0.1 wt % or 0 wt %, with respect to a total amount of (of 100 wt % of) the binder.

In one or more embodiments, a total amount of the aromatic vinyl-based monomer, the (meth)acrylic ester-based monomer, and the triene-based monomer may be about 99.5 wt % or more, for example, about 99.8 to about 100 wt %, for example 100 wt %, with respect to a total amount of the monomer mixture.

Hereinafter, the preceding monomers will be described in more detail.

The triene-based monomer may be a monomer having three double bonds in the monomer and may be, for example, a monomer having the structure of Chemical Formula 1.

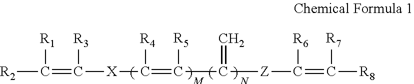

in Chemical Formula 1,
R₁, R₂, R₃, R₄, R₅, R₆, R₇, and R₈ may each independently be hydrogen or a C₁ to C₅ alkyl group,
X and Z may each independently be a single bond or a C₁ to C₅ alkylene group,
M and N may each independently be 0 or 1, and M+N may be 1.

In Chemical Formula 1, a “single bond” refers to a bond in which carbon atoms (C and C) are directly connected.

In one or more embodiments, R₁, R₂, R₃, R₄, R₅, R₆, R₇, and R₈ may each independently be hydrogen or a C₁ to C₃ alkyl group, for example, hydrogen or a methyl group.

In one or more embodiments, R₁ and R₂ may each independently be a C₁ to C₅ alkyl group, for example, a C₁ to C₃ alkyl group, for example, a methyl group. The compound of Chemical Formula 1, in which R₁ and R₂ are connected to a carbon atom that has a double bond (e.g., to another carbon atom) are each a C₁ to C₅ alkyl group, for example, a C₁ to C₃ alkyl group, for example, a methyl group. For example, R₁ and R₂ may allow the side chain of the binder to be branched to enable additional interaction with a current collector, and thus adhesion to the current collector may increase.

In one or more embodiments, X and Z may each independently be a single bond or a C₁ to C₃ alkylene group, for example, a methylene group, an ethylene group, or a propylene group.

For example, the compound of Chemical Formula 1 may include at least one selected from among (e.g., one or more of) myrcene (Chemical Formula 1-1), ocimene (Chemical Formula 1-2), and alloocimene (Chemical Formula 1-3):

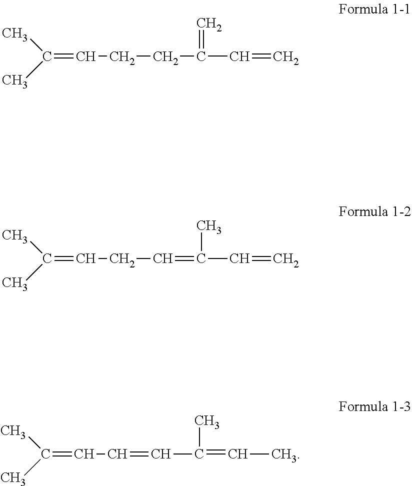

The (meth)acrylic ester-based monomer may decrease the negative plate resistance of the binder by being included in the monomer mixture.

The (meth)acrylic ester-based monomer may be a (meth)acrylic ester having an ester moiety, and having a substituted or unsubstituted straight-chain or branched C1 to C20 alkyl group at the ester moiety. For example, the (meth)acrylic ester-based monomer may be 2-ethylhexyl (meth)acrylate, methyl (meth)acrylate, ethyl (meth)acrylate, propyl (meth)acrylate, isopropyl (meth)acrylate, n-butyl (meth)acrylate, isobutyl (meth)acrylate, n-amyl (meth)acrylate, isoamyl (meth)acrylate, n-hexyl (meth)acrylate, hydroxyethyl (meth)acrylate, hydroxypropyl (meth)acrylate, isobornyl acrylate, isovinyl acrylate, isovinyl methacrylate, and/or a (e.g., any suitable) combination thereof.

In one or more embodiments, the (meth)acrylic ester-based monomer may be a (meth)acrylic ester having an unsubstituted straight-chain C1 to C20 alkyl group, for example, a (meth)acrylic ester having an unsubstituted straight-chain or branched C1 to C10 or C1 to C5 alkyl group.

In one or more embodiments, the (meth)acrylic ester-based monomer may be a (meth)acrylic ester having a C1 to C20 alkyl group and substituted with one or more hydroxyl groups, for example, a (meth)acrylic ester having an unsubstituted straight-chain or branched C1 to C10 or C1 to C5 alkyl group.

The (meth)acrylic ester-based monomer may be included in an amount of about 5 wt % to about 45 wt % with respect to a total amount of the monomer mixture. Within the described range, the aspect of decreasing electrode plate resistance may be achieved or implemented, and an appropriate or suitable amount thereof may prevent or reduce a decrease in adhesion to a current collector. For example, the monomer may be included in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, or 45 wt %, for example, about 5 to about 35 wt % or about 10 to about 35 wt %, with respect to a total amount of the monomer mixture.

The aromatic vinyl-based monomer may be a substituted or unsubstituted styrene-based monomer and may be styrene, α-methyl styrene, β-methyl styrene, p-t-butyl styrene, chlorostyrene, and/or a (e.g., any suitable) combination thereof.

The aromatic vinyl-based monomer may be included in an amount of about 10 wt % to about 90 wt % with respect to a total amount of the monomer mixture. Within the described range, a hard domain for imparting elasticity to the binder may be formed. For example, the monomer may be included in an amount of about 10, 15, 20, 25, 30, 35, 40, 45, 50, 55, 60, 65, 70, 75, 80, 85, or 90 wt %, for example, about 30 wt % to about 70 wt %, for example, about 40 wt % to about 60 wt %, with respect to a total amount of the monomer mixture.

According to one or more embodiments, the binder may be an aqueous binder. Therefore, the binder may be appropriately or suitably applied in a negative electrode, but the present disclosure is not limited thereto.

The binder according to one or more embodiments may be prepared by polymerizing the monomer mixture through a typical method suitable in the art. The polymerization process may be emulsion polymerization, suspension polymerization, solution polymerization, and/or the like.

Emulsion polymerization may be performed in the presence of an emulsifier. The emulsifier may be alkali salts of higher fatty acids, salts of N-acrylic amino acids, alkyl ether carbonates, acylated peptides, alkyl sulfonates, alkyl benzene sulfonates, salts of alkyl amino acids, alkyl naphthalene sulfonates, sulfosuccinates, sulfonated oils, alkyl sulfates, alkyl ether sulfates, alkylaryl ether sulfates, alkyl amide sulfates, alkyl phosphates, alkyl ether phosphates, alkylaryl ether phosphates, and/or a (e.g., any suitable) combination thereof. For example, the emulsifier may be sodium dodecylbenzene sulfonate. In some embodiments, an alkyl group of the emulsifier may be a C1 to C20 alkyl group.

An initiator may be an azo compound initiator such as azoisobutyronitrile and/or the like, ammonium persulfate, potassium persulfate, hydrogen peroxide, t-butyl hydroperoxide, and/or a (e.g., any suitable) combination thereof.

The emulsifier may be included in an amount of about 0.1 parts by weight to about 3 parts by weight, for example, about 0.1 parts by weight to about 2 parts by weight, with respect to the total content (e.g., amount) (100 parts by weight) of the monomer mixture. If (e.g., when) the content (e.g., amount) of the emulsifier falls within the described ranges, adhesion can be improved, and a binder with a size more suitable for facilitating dispersion may be obtained.

The initiator may be included in an amount of about 0.1 parts by weight to about 3 parts by weight, for example, about 0.1 parts by weight to about 2 parts by weight, with respect to the total content (e.g., amount) (100 parts by weight) of the monomer mixture.

The binder may (e.g., may be in a form of particles that) have an average particle diameter (D50) of about 10 nanometer (nm) to about 500 nm, for example, about 50 nm to about 300 nm. Within the described ranges, a negative electrode whose processability is appropriately or suitably secured may be manufactured. In the present specification, when particles are spherical, “diameter” indicates an average particle diameter, and when the particles are non-spherical, the “diameter” indicates a major axis length.

### Negative Electrode for Rechargeable Lithium Battery

A negative electrode for a rechargeable lithium battery may include a current collector and a negative electrode active material layer arranged on the current collector, and the negative electrode mixture layer may include the herein-described binder for a negative electrode of a rechargeable lithium battery. The negative electrode active material layer may further include a negative electrode active material. The negative electrode active material layer may further include a conductive material. The negative electrode active material layer may further include other binders in addition to the herein-described binder for a negative electrode of a rechargeable lithium battery.

For example, the negative electrode active material layer may include about 90 wt % to about 99 wt % of the negative electrode active material, about 0.5 wt % to about 5 wt % of the binder, and about 0 wt % to about 5 wt % for example about 0.5 wt % to about 5 wt % of the conductive material.

The negative electrode active material may include a material capable of reversibly intercalating/deintercalating lithium ions, a lithium metal, a lithium metal alloy, a material capable of doping and dedoping lithium, or a transition metal oxide.

As the material capable of reversibly intercalating/deintercalating lithium ions, a carbon-based negative electrode active material, for example, crystalline carbon, amorphous carbon, and/or a (e.g., any suitable) combination thereof may be used. Examples of the crystalline carbon include amorphous, platy, flaky, spherical, or fibrous natural graphite or artificial graphite, and examples of the amorphous carbon include soft carbon, hard carbon, mesophase pitch carbide, calcined cokes, and/or the like.

As the lithium metal alloy, an alloy of lithium and a metal selected from among Na, K, Rb, Cs, Fr, Be, Mg, Ca, Sr, Si, Sb, Pb, In, Zn, Ba, Ra, Ge, Al, and Sn may be used.

As the material capable of doping and dedoping lithium, an Si-based negative electrode active material or an Sn-based negative electrode active material may be used. The Si-based negative electrode active material may be silicon, a silicon-carbon composite, SiOx (0<x≤2), an Si-Q alloy (wherein Q is selected from among an alkali metal, an alkaline earth metal, a Group 13 element, a Group 14 element (excluding Si), a Group 15 element, a Group 16 element, a transition metal, a rare earth element, and/or a (e.g., any suitable) combination thereof), and/or a (e.g., any suitable) combination thereof. The Sn-based negative electrode active material may be Sn, SnO₂, SnOx (0<x<2), an Sn-based alloy, and/or a (e.g., any suitable) combination thereof.

The silicon-carbon composite may be a composite of silicon and amorphous carbon. According to one or more embodiments, the silicon-carbon composite may be in a form in which silicon particles (primary silicon particles) are coated with amorphous carbon. For example, the silicon-carbon composite may include a secondary particle (core) formed by agglomerating the primary silicon particles and an amorphous carbon coating layer (shell) arranged on the surface of the secondary particle. The amorphous carbon may also be arranged between the primary silicon particles, and thus the primary silicon particles may be coated with the amorphous carbon. The secondary particle may be present in a dispersed state in an amorphous carbon matrix.

The silicon-carbon composite may further include crystalline carbon. For example, the silicon-carbon composite may include a core containing crystalline carbon and silicon particles (primary silicon particles) and an amorphous carbon coating layer arranged on the surface of the core.

The Si-based negative electrode active material or Sn-based negative electrode active material may be used in combination with the carbon-based negative electrode active material.

According to one or more embodiments, the negative electrode may include only the binder for a negative electrode of a rechargeable lithium battery as a binder.

According to one or more embodiments, the negative electrode may further include other binders in addition to the binder for a negative electrode of a rechargeable lithium battery. As other binders, a non-aqueous binder, an aqueous binder, a dry binder, and/or a (e.g., any suitable) combination thereof may be used.

The non-aqueous binder may be polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, and/or a (e.g., any suitable) combination thereof.

The aqueous binder may be selected from among styrene-butadiene rubber, (meth)acrylated styrene-butadiene rubber, (meth)acrylonitrile-butadiene rubber, (meth)acrylic rubber, butyl rubber, fluorine rubber, polyethylene oxide, polyvinyl pyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and/or a (e.g., any suitable) combination thereof.

If (e.g., when) the aqueous binder is used as the negative electrode binder, a cellulose-based compound capable of imparting viscosity may be further included. As the cellulose-based compound, a mixture of one or more of carboxymethyl cellulose, hydroxypropylmethyl cellulose, methyl cellulose, and an alkali metal salt thereof may be used. As the alkali metal, Na, K, or Li may be used.

The dry binder is a polymer material that allows fiberization, and may be, for example, polytetrafluoroethylene, polyvinylidene fluoride, a polyvinylidene fluoride-hexafluoropropylene copolymer, polyethylene oxide, and/or a (e.g., any suitable) combination thereof.

The conductive material may be used to impart conductivity to an electrode, and any conductive material may be used as long as it does not cause a chemical change in the battery and is an electronically conductive material. Non-limiting examples of the conductive material include: a carbon-based material such as natural graphite, artificial graphite, carbon black, acetylene black, Ketjen black, a carbon fiber, a carbon nanofiber, a carbon nanotube, and/or the like; a metal-based material that includes copper, nickel, aluminum, silver, and/or the like and is in the form of a metal powder or metal fiber; a conductive polymer such as a polyphenylene derivative and/or the like; and/or a (e.g., any suitable) mixture thereof.

The negative electrode current collector may be selected from among copper foil, nickel foil, stainless steel foil, titanium foil, nickel foam, copper foam, a conductive metal-coated polymer substrate, and/or a (e.g., any suitable) combination thereof.

The negative electrode active material layer may further include an additive. The additive may include one or more of a thickener, a dispersant, and a filler.

The content (e.g., amount) of the additive varies depending on the type or kind of active material, the composition of a binder, and the type or kind of additive, and may be about 0.1 wt % to about 10 wt % relative to a binder composition excluding a solvent. Within the described range, the aspect of the additive may be exhibited, and a relative proportion of the binder in the binder composition for a negative electrode may be secured to exhibit a desired or suitable aspect caused by the binder.

The thickener may serve to facilitate an application process on a current collector by being added if (e.g., when) the viscosity of a slurry is low. As the thickener, for example, one or more of carboxymethyl cellulose, carboxyethyl cellulose, ethyl cellulose, hydroxymethyl cellulose, hydroxyethyl cellulose, hydroxypropyl cellulose, and polyvinyl alcohol may be selected and used. If (e.g., when) the negative electrode active material layer further includes the conductive material, the negative electrode active material layer may include about 90 wt % to about 98 wt % of the negative electrode active material, about 1 wt % to about 5 wt % of the binder, and about 1 wt % to about 5 wt % of the thickener.

The dispersant may be selected from among materials that enhance the dispersibility of a negative electrode active material and a conductive material in a slurry. The dispersant may be selected from among cationic, anionic, and non-ionic dispersants, and one or more of materials whose lipophilic portion is a C5 to C20 hydrocarbon, an acrylic oligomer, an ethylene oxide oligomer, a propylene oxide oligomer, an ethylene oxide/propylene oxide oligomer, or a urethane oligomer may be selected and used.

The current collector may be selected from among copper foil, nickel foil, stainless steel foil, titanium foil, nickel foam, copper foam, a conductive metal-coated polymer substrate, and/or a (e.g., any suitable) combination thereof.

### Rechargeable Lithium Battery

According to another aspect of the present disclosure, there is provided a rechargeable lithium battery including the herein-described negative electrode, a positive electrode, and an electrolyte.

### Positive Electrode

A positive electrode for a rechargeable lithium battery may include a current collector and a positive electrode active material layer formed on the current collector. The positive electrode active material layer may include a positive electrode active material and may further include a binder and/or a conductive material.

In one or more embodiments, the positive electrode may further include an additive capable of serving as a sacrificial positive electrode.

The positive electrode active material may be included in an amount of about 90 wt % to about 99.5 wt % with respect to 100 wt % of the positive electrode active material layer, and the binder and the conductive material may each be included in an amount of about 0.5 wt % to about 5 wt % with respect to 100 wt % of the positive electrode active material layer.

As the positive electrode active material, a compound capable of reversibly intercalating/deintercalating lithium ions (lithium intercalation compound) may be used. For example, one or more composite oxides of lithium and a metal selected from among cobalt, manganese, nickel, and/or a (e.g., any suitable) combination thereof may be used.

The composite oxide may be a lithium transition metal composite oxide, and non-limiting examples thereof include a lithium nickel oxide, a lithium cobalt oxide, a lithium manganese oxide, a lithium iron phosphate compound, a cobalt-free nickel manganese oxide, and/or a (e.g., any suitable) combination thereof.

In one or more embodiments, the positive electrode active material may be a compound represented by any one of the following chemical formulas: LiₐA_{1-b}X_{b}O_{2-c}D_{c} (0.90<a≤1.8, 0<b≤0.5, 0≤c≤0.05); LiₐMn_{2-b}X_{b}O_{4-c}D_{c} (0.90≤a≤1.8, 0<b≤0.5, 0≤c≤0.05); LiₐNi_{1-b-c} CO_{b}X_{c}O₂₋ₐDₐ (0.90≤a≤1.8, 0≤b≤0.5, 0≤c≤0.5, 0<a<2); LiₐNi_{1-b-c}Mn_{b}X_{c}O₂₋ₐDₐ (0.90≤a≤1.8, 0≤b≤0.5, 0≤c≤0.5, 0<a<2); LiₐNi_{b} Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); Liₐ CoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the chemical formulas, A may be Ni, Co, Mn, and/or a (e.g., any suitable) combination thereof; X may be Al, Ni, Co, Mn, Cr, Fe, Mg, Sr, V, a rare earth element, and/or a (e.g., any suitable) combination thereof; D may be O, F, S, P, and/or a (e.g., any suitable) combination thereof; G may be Al, Cr, Mn, Fe, Mg, La, Ce, Sr, V, and/or a (e.g., any suitable) combination thereof; and L¹ may be Mn, Al, and/or a (e.g., any suitable) combination thereof.

In one or more embodiments, the positive electrode active material may be a nickel-rich positive electrode active material including nickel in an amount of about 80 mol % or more, about 85 mol % or more, about 90 mol % or more, about 91 mol % or more, or about 94 mol % or more, and about 99 mol % or less with respect to 100 mol % of metals (excluding lithium) in the lithium transition metal composite oxide. The nickel-rich positive electrode active material may implement high capacity and thus may be applied in a rechargeable lithium battery with high capacity and high density.

The binder may serve to smoothly adhere positive electrode active material particles to each other and smoothly adhere a positive electrode active material to a current collector. Representative examples of the binder include polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, an epoxy resin, a (meth)acrylic resin, a polyester resin, nylon, and/or the like, but the present disclosure is not limited thereto.

The conductive material may be used to impart conductivity to an electrode, and any conductive material may be used as long as it does not cause a chemical change in the battery and is an electronically conductive material. Non-limiting examples of the conductive material include: a carbon-based material such as natural graphite, artificial graphite, carbon black, acetylene black, Ketjen black, a carbon fiber, a carbon nanofiber, a carbon nanotube, and/or the like; a metal-based material that includes copper, nickel, aluminum, silver, and/or the like and is in the form of a metal powder or metal fiber; a conductive polymer such as a polyphenylene derivative and/or the like; and/or a (e.g., any suitable) mixture thereof.

As the current collector, Al may be used, but the present disclosure is not limited thereto.

### Electrolyte

An electrolyte for a rechargeable lithium battery includes a non-aqueous organic solvent and a lithium salt.

The non-aqueous organic solvent may serve as a medium through which ions involved in the electrochemical reaction of a battery may migrate.

The non-aqueous organic solvent may be a carbonate-based, ester-based, ether-based, ketone-based, or alcohol-based solvent, an aprotic solvent, and/or a (e.g., any suitable) combination thereof.

As the carbonate-based solvent, dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like may be used.

As the ester-based solvent, methyl acetate, ethyl acetate, n-propyl acetate, dimethyl acetate, methyl propionate, ethyl propionate, decanolide, mevalonolactone, valerolactone, caprolactone, and/or the like may be used.

As the ether-based solvent, dibutyl ether, tetraglyme, diglyme, dimethoxyethane, 2-methyltetrahydrofuran, 2,5-dimethyltetrahydrofuran, tetrahydrofuran, and/or the like may be used. As the ketone-based solvent, cyclohexanone and/or the like may be used. As the alcohol-based solvent, ethyl alcohol, isopropyl alcohol, and/or the like may be used, and as the aprotic solvent, a nitrile such as R-CN (R is a C2 to C20 straight-chain, branched, or cyclic hydrocarbon group and may include a double bond, an aromatic ring, or an ether group); an amide such as dimethylformamide and/or the like; a dioxolane such as 1,3-dioxolane, 1,4-dioxolane, and/or the like; a sulfolane; and/or the like may be used.

As the non-aqueous organic solvent, those precedingly listed herein may be used alone or in combination of two or more thereof.

In some embodiments, if (e.g., when) the carbonate-based solvent is used, a mixture of a cyclic carbonate and a chain carbonate may be used, and the cyclic carbonate and the chain carbonate may be mixed in a volume ratio of 1:1 to 1:9.

The lithium salt may be a material that acts as a source of lithium ions in a battery to allow the basic operation of a rechargeable lithium battery by being dissolved in an organic solvent and serves to promote the migration of lithium ions between a positive electrode and a negative electrode. Representative examples of the lithium salt include at least one (e.g., one, or two or more) selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSI), LiC₄F₉SO₃, LiN(CₓF₂ₓ₊₁SO₂) (C_{y}F_{2y+1}SO₂) (x and y are an integer of 1 to 20), lithium trifluoromethanesulfonate, lithium tetrafluoroethanesulfonate, lithium difluoro bis(oxalato) phosphate (LiDFOB), and lithium bis(oxalato) borate (LiBOB).

Depending on the type or kind of rechargeable lithium battery, a separator may be present between the positive electrode and the negative electrode.

### Separator

As a separator, polyethylene, polypropylene, polyvinylidene fluoride, or a multi-layer membrane of two or more layers thereof may be used, and a mixed multi-layer membrane such as a double-layer separator of polyethylene/polypropylene, a triple-layer separator of polyethylene/polypropylene/polyethylene, and a triple-layer separator of polypropylene/polyethylene/polypropylene may be used.

The separator may include a porous substrate and a coating layer which is arranged on one surface or both surfaces (e.g., opposite surfaces) of the porous substrate and may include an organic material, an inorganic material, and/or a (e.g., any suitable) combination thereof.

The porous substrate may be a polymer membrane formed of any one polymer or a copolymer or mixture of at least two (e.g., two or more) selected from among a polyolefin such as polyethylene, polypropylene, and/or the like, a polyester such as polyethylene terephthalate, polybutylene terephthalate, and/or the like, polyacetal, polyamide, polyimide, polycarbonate, polyether ketone, polyaryletherketone, polyetherimide, polyamideimide, polybenzimidazole, polyethersulfone, polyphenylene oxide, a cyclic olefin copolymer, polyphenylene sulfide, polyethylene naphthalate, glass fiber, TEFLON, and polytetrafluoroethylene.

The organic material may include a polyvinylidene fluoride-based polymer or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or a (e.g., any suitable) combination thereof, but the present disclosure is not limited thereto.

The organic material and inorganic material may be present in a mixed state in one coating layer, or in a form in which a coating layer including (e.g., containing) the organic material and a coating layer including (e.g., containing) the inorganic material are stacked.

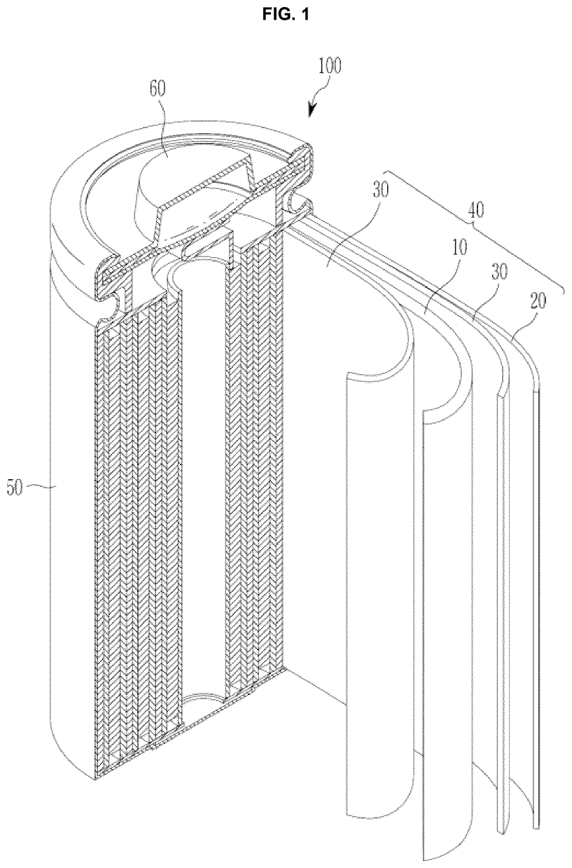

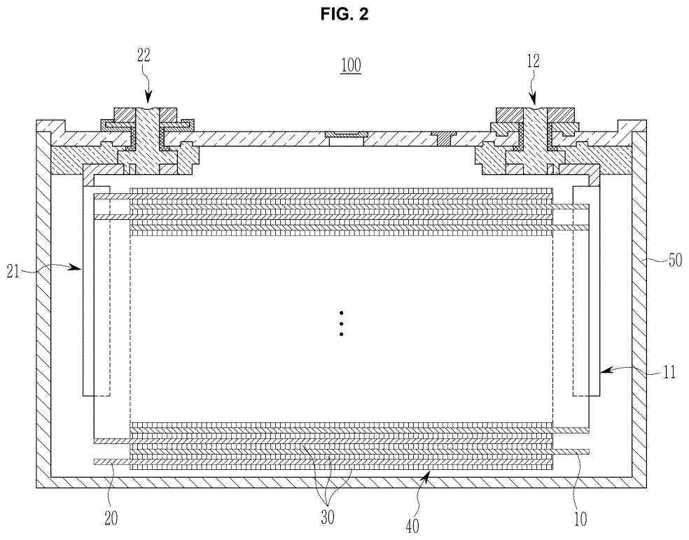

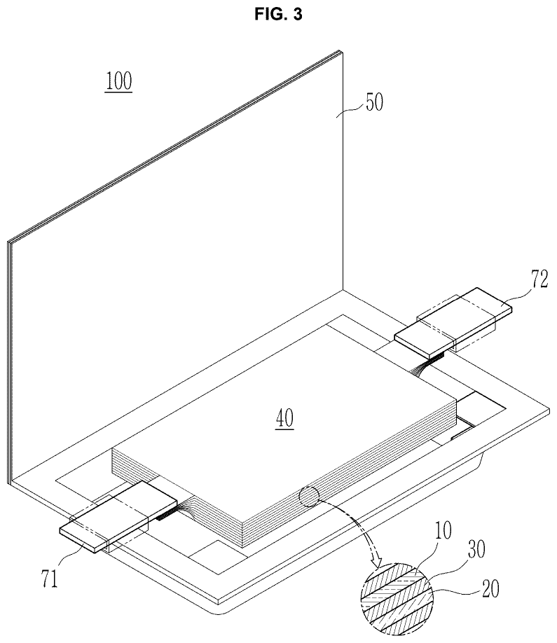

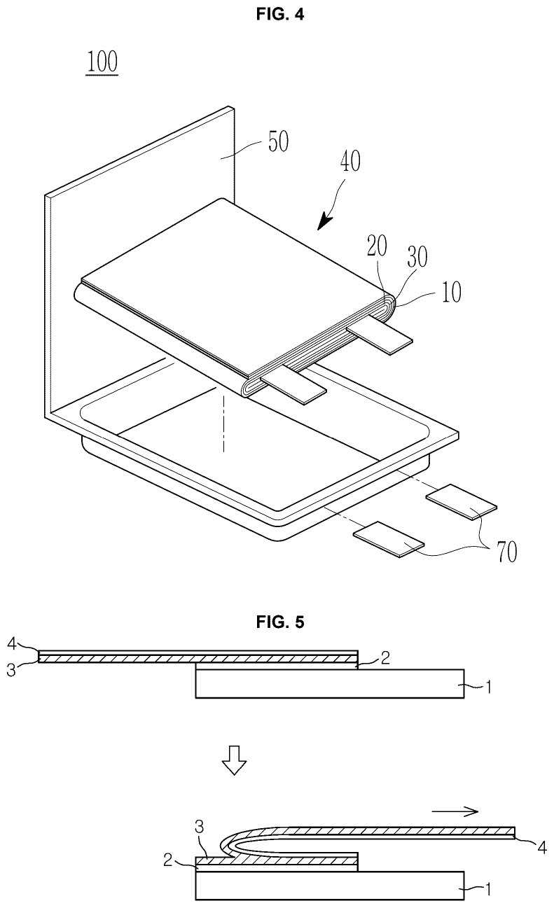

The rechargeable lithium battery may be classified into a cylindrical form, a prismatic form, a pouch form, a coin form, and/or the like depending on the shape thereof. FIGS. 1 to 4 are each a schematic diagram of a rechargeable lithium battery according to one or more embodiments, FIG. 1 shows a cylindrical battery, FIG. 2 shows a prismatic battery, and FIGS. 3 and 4 show pouch-type or kind batteries. Referring to FIGS. 1 to 4, a rechargeable lithium battery 100 may include an electrode assembly 40, in which a separator 30 is interposed between a positive electrode 10 and a negative electrode 20, and a case 50 in which the electrode assembly 40 is embedded. The positive electrode 10, the negative electrode 20, and the separator 30 may be impregnated with an electrolyte. The rechargeable lithium battery 100 may include a sealing member 60 that seals the case 50 as shown in FIG. 1. Also, in FIG. 2, the rechargeable lithium battery 100 may include a positive electrode lead tab 11, a positive electrode terminal 12, a negative electrode lead tab 21, and a negative electrode terminal 22. As shown in FIGS. 3 and 4, the rechargeable lithium battery 100 may include electrode tabs 70 (i.e., a positive electrode tab 71 and a negative electrode tab 72), which may serve as an electrical passage for directing the current formed in the electrode assembly 40 to the outside.

The rechargeable lithium battery according to one or more embodiments of the present disclosure may be applied in vehicles, mobile phones, and/or one or more suitable types (kinds) of electrical devices, but the present disclosure is not limited thereto.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or +30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

Hereinafter, examples and comparative examples of the present disclosure will be described. The following examples are given for the purpose of illustration only and are not intended to limit the scope of the present disclosure.

### EXAMPLES

### Example 1

Based on a total of 100 wt %, 15 wt % of myrcene, 35 wt % of n-butyl acrylate, and 50 wt % of styrene were mixed to obtain a monomer mixture. 100 parts by weight of the obtained mixture was mixed with a sodium dodecylbenzene sulfonate emulsifier, an azo compound initiator, and water. In this case, the emulsifier was used in an amount of 0.3 parts by weight with respect to 100 parts by weight of the mixture, and the initiator was used in an amount of 0.5 parts by weight with respect to 100 parts by weight of the mixture.

Subsequently, the resulting mixture was subjected to emulsion polymerization to prepare an aqueous binder dispersion containing a copolymer including a unit derived from myrcene, a unit derived from n-butyl acrylate, and a unit derived from styrene.

The aqueous binder dispersion, a carboxymethyl cellulose thickener, and a mixture of graphite and a silicon-carbon composite as a negative electrode active material were mixed in a water solvent to prepare a negative electrode active material slurry. In this case, the negative electrode active material slurry was prepared so that, based on a solid content (e.g., amount) excluding water, 97 wt % of the negative electrode active material, 1 wt % of the carboxymethyl cellulose thickener, and 2 wt % of the binder were included.

The negative electrode active material slurry was applied onto a copper foil current collector, dried, and roll-pressed to manufacture a negative electrode.

A battery having a cell capacity of 700 milliampere hour (mAh) was manufactured by a typical method using the negative electrode, a positive electrode, and an electrolyte. As the electrolyte, an electrolyte obtained by dissolving 1.5 M LiPF₆ in ethylene carbonate:ethyl methyl carbonate:dimethyl carbonate (in a volume ratio of 30:50:20) was used. As the positive electrode, a positive electrode formed by mixing 96 wt % of LiCoO₂, 2 wt % of Ketjen black, and 2 wt % of polyvinylidene fluoride in a N-methyl pyrrolidone solvent to prepare a positive electrode active material slurry, applying the positive electrode active material slurry onto an aluminum current collector, and performing drying and roll pressing was used.

### Examples 2 to 5

An aqueous binder dispersion was prepared in substantially the same manner as in Example 1, except that based on a total of 100 wt %, the contents (e.g., amounts) of myrcene, n-butyl acrylate, and styrene in a monomer mixture were changed as shown in Table 1. A negative electrode and a battery were manufactured in substantially the same manner as in Example 1, except that the resulting aqueous binder dispersion was used.

### Example 6

An aqueous binder dispersion was prepared in substantially the same manner as in Example 1, except that based on a total of 100 wt %, the contents (e.g., amounts) of ocimene, n-butyl acrylate, and styrene in a monomer mixture were changed as shown in Table 1. A negative electrode and a battery were manufactured in substantially the same manner as in Example 1, except that the resulting aqueous binder dispersion was used.

### Example 7

An aqueous binder dispersion was prepared in substantially the same manner as in Example 1, except that based on a total of 100 wt %, the contents (e.g., amounts) of allocimene, n-butyl acrylate, and styrene in a monomer mixture were changed as shown in Table 1. A negative electrode and a battery were manufactured in substantially the same manner as in Example 1, except that the resulting aqueous binder dispersion was used.

### Comparative Example 1

An aqueous binder dispersion was prepared in substantially the same manner as in Example 1, except that based on a total of 100 wt %, 50 wt % of n-butyl acrylate and 50 wt % of styrene were used in a monomer mixture. A negative electrode and a battery were manufactured in substantially the same manner as in Example 1, except that the resulting aqueous binder dispersion was used.

### Comparative Example 2

An aqueous binder dispersion was prepared in substantially the same manner as in Example 1, except that based on a total of 100 wt %, 50 wt % of styrene and 50 wt % of butadiene were used in a monomer mixture. A negative electrode and a battery were manufactured in substantially the same manner as in Example 1, except that the resulting aqueous binder dispersion was used.

### Comparative Example 3

An aqueous binder dispersion was prepared in substantially the same manner as in Example 1, except that based on a total of 100 wt %, 35 wt % of n-butyl acrylate, 50 wt % of styrene, and 15 wt % of butadiene were used in a monomer mixture. A negative electrode and a battery were manufactured in substantially the same manner as in Example 1, except that the resulting aqueous binder dispersion was used.

In Table 1, “-” indicates that the corresponding monomer was not included (the corresponding monomer content (e.g., amount) was 0 wt %).

### Experimental Example 1: Direct Current Internal Resistance (DC-IR, Units: mΩ)

Each battery with a cell capacity of 700 milliampere hour (mAh), which was manufactured according to the preceding examples and comparative examples, was subjected to one-time charging and discharging with charging at room temperature at a constant current/constant voltage of 0.2 C/4.2V and a 0.05 C cut-off, resting for 10 minutes, discharging at a constant current of 0.33 C and a 2.5V cut-off, and resting for 10 minutes. The voltage drop (V) that occurred while passing a current of 1 C at a state of charge 50 (SOC50), which is a state in which the battery is charged to a charge capacity of 50% if (e.g., when) the total charge capacity of the battery is set to 100%, and this also refers to that the battery is discharged to 50%, for 10 seconds was measured to measure direct current internal resistance (DC-IR). In some embodiments, the DC-IR was 100 milliohm (m (2) or less.

### Experimental Example 2: Adhesion (Units: Gf/Mm)

The adhesion between the current collector and negative electrode mixture layer in each negative electrode manufactured according to the preceding examples and comparative examples was measured using a UTM tensile strength tester. FIG. 5 shows a method of adhesion measurement in which a slide glass 1 (length×width=7 cm×2.5 cm) was attached to one surface of a double-sided adhesive tape 2 (length×width=4 cm×2.5 cm), and the negative electrode (3+4) was attached to the other surface of the double-sided adhesive tape to prepare a sample of FIG. 5. The negative electrode (3+4) included the current collector 4 and the negative electrode mixture layer 3 each having length×width=7 cm×2.5 cm. The sample was mounted on a Universal Testing Machine (UTM) tensile strength tester, and the adhesion if (e.g., when) the negative electrode (3+4) was detached from the slide glass 1 in the direction of the arrow at a peeling angle of 180°, a peeling temperature of 25° C., and a peeling speed of 100 millimeter per minute (mm/min) was measured. In some embodiments, the adhesion was 1.20 gram force per millimeter (gf/mm) or more.

TABLE 1

| | | | | | | | DC- | |
|---|---|---|---|---|---|---|---|---|
| | Triene-based monomer | | | n-Butyl | | | IR | Adhesion |
| | Myrcene | Ocimene | Alloocimene | acrylate | Styrene | Butadiene | (mΩ) | (gf/mm) |
| Example 1 | 15 | — | — | 35 | 50 | — | 92 | 1.31 |
| Example 2 | 5 | — | — | 45 | 50 | — | 90 | 1.20 |
| Example 3 | 25 | — | — | 25 | 50 | — | 96 | 1.38 |
| Example 4 | 35 | — | — | 15 | 50 | — | 99 | 1.42 |
| Example 5 | 45 | — | — | 5 | 50 | — | 100 | 1.44 |
| Example 6 | — | 15 | — | 35 | 50 | — | 94 | 1.35 |
| Example 7 | — | — | 15 | 35 | 50 | — | 91 | 1.21 |
| Comparative | — | — | — | 50 | 50 | — | 89 | 1.05 |
| Example 1 | | | | | | | | |
| Comparative | — | — | — | — | 50 | 50 | 102 | 1.29 |
| Example 2 | | | | | | | | |
| Comparative | — | — | — | 35 | 50 | 15 | 97 | 1.09 |
| Example 3 | | | | | | | | |

As shown in Table 1, the binder for the negative electrode of the rechargeable lithium batteries according to Examples 1 to 7 provided a negative electrode mixture layer having low electrode plate resistance and high adhesion to a current collector.

A battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the components of the device may be formed on one integrated circuit (IC) chip or on separate IC chips. Further, the components of the device may be implemented on a flexible printed circuit film, a tape carrier package (TCP), a printed circuit board (PCB), or formed on one substrate. Further, the components of the device may be a process or thread, running on one or more processors, in one or more computing devices, executing computer program instructions and interacting with other system components for performing the functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of computing devices may be combined or integrated into a single computing device, or the functionality of a particular computing device may be distributed across one or more other computing devices without departing from the scope of the present disclosure.

Example embodiments of the present disclosure have been described, but the present disclosure is not limited thereto. One or more suitable other modifications may be implemented within the scope of the claims, the detailed description of the present disclosure, and the appended drawings, and are also included in the scope of the present disclosure. Accordingly, any modified embodiments may not be understood separately from the technical ideas and aspects of the present disclosure, and the modified embodiments are within the scope of the appended claims and equivalents thereof.

What is claimed is:

1. A binder comprising:
a unit derived from an aromatic vinyl-based monomer;
a unit derived from a (meth)acrylic ester-based monomer; and
a unit derived from a triene-based monomer,
wherein the binder is for a negative electrode of a rechargeable lithium battery.

2. The binder as claimed in claim 1, wherein the triene-based monomer is a monomer comprising Chemical Formula 1: 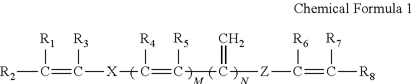
in Chemical Formula 1,
R₁, R₂, R₃, R₄, R₅, R₆, R₇, and R₅ are each independently hydrogen or a C1 to C5 alkyl group,
X and Z are each independently a single bond or a C1 to C5 alkylene group,
M and N are each independently 0 or 1, and
M+N is 1.

3. The binder as claimed in claim 1, wherein the triene-based monomer comprises at least one selected from among myrcene (Chemical Formula 1-1), ocimene (Chemical Formula 1-2), and alloocimene (Chemical Formula 1-3):

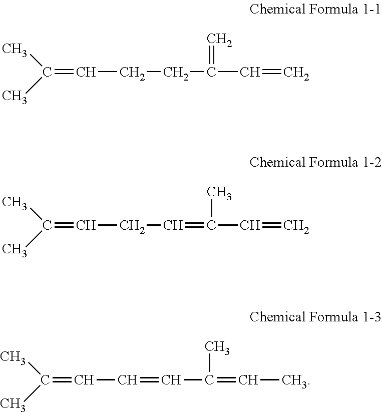

4. The binder as claimed in claim 1, wherein the (meth)acrylic ester-based monomer is a (meth)acrylic ester having a substituted or unsubstituted straight-chain or branched C1 to C20 alkyl group at an ester moiety.

5. The binder as claimed in claim 1, wherein the aromatic vinyl-based monomer is a substituted or unsubstituted styrene-based monomer.

6. The binder as claimed in claim 1, wherein the binder is an aqueous binder.

7. The binder as claimed in claim 1, wherein the binder is a (meth)acrylic copolymer of a monomer mixture comprising an aromatic vinyl-based monomer, a (meth)acrylic ester-based monomer, and a triene-based monomer.

8. The binder as claimed in claim 7, wherein the triene-based monomer is in an amount of 1 to 100 parts by weight with respect to a total amount of 100 parts by weight of the aromatic vinyl-based monomer and the (meth)acrylic ester-based monomer.

9. The binder as claimed in claim 7, wherein the triene-based monomer is in an amount of about 3 wt % to about 45 wt % with respect to a total amount of the monomer mixture.

10. The binder as claimed in claim 7, wherein the monomer mixture comprises:
about 3 wt % to about 45 wt % of the triene-based monomer,
about 5 wt % to about 45 wt % of the (meth)acrylic ester-based monomer, and
about 10 wt % to about 90 wt % of the aromatic vinyl-based monomer,
with respect to a total amount of the monomer mixture.

11. The binder as claimed in claim 10, wherein the triene-based monomer is at least one selected from among myrcene, ocimene, allocimene, and combinations thereof.

12. The binder as claimed in claim 10, wherein the (meth)acrylic ester-based monomer is at least one selected from among 2-ethylhexyl (meth)acrylate, methyl (meth)acrylate, ethyl (meth)acrylate, propyl (meth)acrylate, isopropyl (meth)acrylate, n-butyl (meth)acrylate, isobutyl (meth)acrylate, n-amyl (meth)acrylate, isoamyl (meth)acrylate, n-hexyl (meth)acrylate, hydroxyethyl (meth)acrylate, hydroxypropyl (meth)acrylate, isobornyl acrylate, isovinyl acrylate, isovinyl methacrylate, and combinations thereof.

13. The binder as claimed in claim 10, wherein the aromatic vinyl-based monomer is at least one selected from among styrene, α-methyl styrene, β-methyl styrene, p-t-butyl styrene, chlorostyrene, and combinations thereof.

14. The binder as claimed in claim 10, wherein the triene-based monomer is myrcene, the (meth)acrylic ester-based monomer is n-butyl acrylate, and the aromatic vinyl-based monomer is styrene.

15. The binder as claimed in claim 7, wherein a total amount of the aromatic vinyl-based monomer, the (meth)acrylic ester-based monomer, and the triene-based monomer is at least about 99.5 wt % with respect to a total amount of the monomer mixture.

16. The binder as claimed in claim 1, wherein the binder comprises a unit derived from a diene-based monomer in an amount of at most about 0.1 wt % with respect to a total amount of the binder.

17. The binder as claimed in claim 1, wherein the binder is in a form of particles that has an average particle diameter (D50) of about 10 nanometer (nm) to about 500 nm.

18. A rechargeable lithium battery comprising:
a negative electrode comprising the binder as claimed in claim 1;
a positive electrode; and
an electrolyte.

19. The rechargeable lithium battery as claimed in claim 18, wherein the binder comprises a (meth)acrylic copolymer of a monomer mixture comprising an aromatic vinyl-based monomer, a (meth)acrylic ester-based monomer, and a triene-based monomer,
the monomer mixture comprising, with respect to a total amount of the monomer mixture:
about 3 wt % to about 45 wt % of the triene-based monomer;
about 5 wt % to about 45 wt % of the (meth)acrylic ester-based monomer; and
about 10 wt % to about 90 wt % of the aromatic vinyl-based monomer.

20. The rechargeable lithium battery as claimed in claim 19, wherein
the triene-based monomer is at least one selected from among myrcene, ocimene, allocimene, and combinations thereof,
the (meth)acrylic ester-based monomer is at least one selected from among 2-ethylhexyl (meth)acrylate, methyl (meth)acrylate, ethyl (meth)acrylate, propyl (meth)acrylate, isopropyl (meth)acrylate, n-butyl (meth)acrylate, isobutyl (meth)acrylate, n-amyl (meth)acrylate, isoamyl (meth)acrylate, n-hexyl (meth)acrylate, hydroxyethyl (meth)acrylate, hydroxypropyl (meth)acrylate, isobornyl acrylate, isovinyl acrylate, isovinyl methacrylate, and combinations thereof, and
the aromatic vinyl-based monomer is at least one selected from among styrene, α-methyl styrene, β-methyl styrene, p-t-butyl styrene, chlorostyrene, and combinations thereof.
